(19) United States
(12) Patent Application Publication
(10) Pub. No.: US 2024/0161626 A1
(43) Pub. Date: May 16, 2024

(54) PASSENGER INFORMATION COLLECTION SYSTEM, PASSENGER INFORMATION COLLECTION METHOD AND PROGRAM RECORDING MEDIUM

(71) Applicant: NEC Corporation, Minato-ku, Tokyo (JP)

(72) Inventors: Kei YANAGISAWA, Tokyo (JP); Hiroaki AMINAKA, Tokyo (JP); Kazuki OGATA, Tokyo (JP); Kosei KOBAYASHI, Tokyo (JP); Tetsuro HASEGAWA, Tokyo (JP)

(73) Assignee: NEC Corporation, Minato-ku, Tokyo (JP)

(21) Appl. No.: 18/283,525

(22) PCT Filed: Mar. 26, 2021
(86) PCT No.: PCT/JP2021/012948

§ 371 Date: Sep. 22, 2023

(51) Int. Cl. G08G 1/00; G06Q 10/02; G06Q 50/47; G06V 40/16

(52) U.S. Cl. CPC G08G 1/202; G06Q 10/02; G06Q 50/47; G06V 40/161

(57) ABSTRACT

A passenger information collection system is capable of acquiring a photographic image from a camera installed in a periphery of a road and including: a reception part that receives user information on a user who made a reservation from a vehicle dispatching system that dispatches a passenger vehicle; an image acquisition part that acquires a photographic image of a person who made a dispatch request for a taxicab, from the camera based on the user information; a confirmation part that confirms whether or not a person is wearing a mask based on an image of the person in the photographic image; and a transmission part that transmits information of whether or not the person who made the dispatch request for the taxicab is wearing a mask to a terminal of a company to which the dispatch request for the taxicab is made.

This application is a National Stage Entry of PCT/JP2021/012948 filed on Mar. 26, 2021, the contents of all of which are incorporated herein by reference, in their entirety.

### FIELD

The present invention relates to a passenger information collection system, a passenger information collection method, and a program recording medium.

### BACKGROUND

In Patent Literature (PTL) 1, the invention is disclosed that, in a system for managing dispatching vehicles such as taxicabs, user's convenience at the time of a dispatch request can be improved by selecting a vehicle to be allocated to the user based on the user's attribute information (see claim 7, etc.). The attribute information in PTL 1 is managed in the user information table of the dispatch management server.

In PTL 2, a bus stop is disclosed that can detect the number of users and whether or not they need assistance at the stop by recognizing the image captured by the camera. The control unit of the bus stop described in PTL 2 then notifies the bus 40 approaching that stop in advance of the number of users and whether or not they need assistance (see paragraph 0027).

In PTL 3, a configuration provided with a camera management system is disclosed in a dispatch system capable of dispatching a movable body configured to perform unmanned driving to a designated dispatch location at an appropriate time. The camera management system configured to include a multiplicity of outdoor surveillance cameras and can capture an image of a user who is moving outdoors.

[PTL 1] Japanese Patent Application Publication No. JP 2020-170572 A

[PTL 2] International Publication No. 2020/145312

[PTL 3] Japanese Patent Application Publication No. JP 2019-101464 A

### SUMMARY

The following analysis is given by the present inventors. Some infectious diseases do not develop immediately after infection but develop after a certain incubation period. It has been pointed out that contact with such an infected person may spread the infection. For this reason, wearing a mask is widely recommended in public places, not only for infected persons.

However, a driver of a passenger vehicle such as a taxicab may encounter a passenger who is not wearing a mask at the pick-up location. For this reason, some taxicab companies have begun to stipulate in their Transportation Clause that they may refuse a passenger a ride if a reason for not wearing a mask is not a legitimate reason, such as illness. However, it is difficult to determine whether or not there is a legitimate reason, such as illness, and this is a burden on the driver.

It is an object of the present invention to provide a passenger information collection system, a passenger information collection method, and a program recording media, which can provide information as to whether or not a person who made a dispatch request is wearing a mask before dispatching a taxicab.

According to a first aspect, there is provided a passenger information collection system, that is capable of acquiring a photographic image from a camera installed in a periphery of a road, including:
a reception part that receives user information on a user who made a reservation from a vehicle dispatching system that dispatches a passenger vehicle;
an image acquisition part that acquires a photographic image of a person who made a dispatch request for a taxicab, from the camera based on the user information;
a confirmation part that confirms whether or not a person is wearing a mask based on an image of the person in the photographic image; and
a transmission part that transmits information of whether or not the person who made the dispatch request for the taxicab is wearing a mask to a terminal of a company to which the dispatch request for the taxicab is made.

According to a second aspect, there is provided a passenger information collection method performed by a passenger information collection system capable of acquiring a photographic image from a camera installed in a periphery of a road, including:
receiving user information on a user who made a reservation from a vehicle dispatching system that dispatches a passenger vehicle;
acquiring a photographic image of a person who made a dispatch request for a taxicab, from the camera based on the user information;
confirming whether or not a person is wearing a mask based on an image of the person in the photographic image; and
transmitting information of whether or not the person who made the dispatch request for the taxicab is wearing a mask to a terminal of a company to which the dispatch request for the taxicab is made.

The present method is associated with a certain machine referred to as a passenger information collection system, capable of acquiring an image by a camera installed in a periphery of a road.

According to a third aspect, there is provided a computer program (hereinafter referred to as a program) for realizing the functions of the above passenger information collection system. This program is supplied to a computer apparatus using an input device or from an outside via a communication interface, is stored in a storage device, and operates a processor according to predetermined steps or processes. Further, this program can display processing results thereof including an intermediate state as necessary via a display device step by step or can communicate with the outside via the communication interface. For example, the computer apparatus for this purpose is typically provided with a processor, a storage device, an input device, a communication interface, and a display device as needed, which can be connected to each other via a bus. In addition, this program can be recorded in a computer-readable (non-transitory) storage medium. The present invention can be implemented as a computer program product.

According to the present invention, information as to whether or not a person who made a dispatch request is wearing a mask can be provided in advance.

### BRIEF DESCRIPTION OF DRAWINGS

FIG. 1 is a drawing illustrating a configuration according to an example embodiment of the present invention.

FIG. 2 is a block diagram illustrating a configuration of a passenger information collection system according to a first example embodiment of the present invention.

FIG. 3 is a diagram illustrating an operation of the passenger information collection system according to the first example embodiment of the present invention.

FIG. 4 is a block diagram illustrating a configuration of a passenger information collection system according to a second example embodiment of the present invention.

FIG. 5 is a diagram illustrating an operation of the passenger information collection system according to the second example embodiment of the present invention.

FIG. 6 is a drawing illustrating a configuration of a computer capable of functioning as a passenger information collection system of the present invention.

### EXAMPLE EMBODIMENTS

First, an outline of an example embodiment of the present invention will be given with reference to drawings. It should be noted that drawing reference signs in the outline are given to each element for convenience as an example to facilitate understanding and are not intended to limit the present invention to the illustrated modes. Further, connection lines between blocks in the drawings referred to in the following description can be both bidirectional and unidirectional. A unidirectional arrow schematically shows the main flow of a signal (data) and does not exclude bidirectionality. Although input/output connection points of each block in the drawings have ports or interfaces, these are not illustrated. A program is executed by a computer apparatus, and the computer apparatus is provided with, for example, a processor, a storage device, an input device, a communication interface, and a display device as needed. Further, the computer apparatus is configured to be able to perform wired or wireless communication with an internal device therein or with an external device (including a computer) via the communication interface.

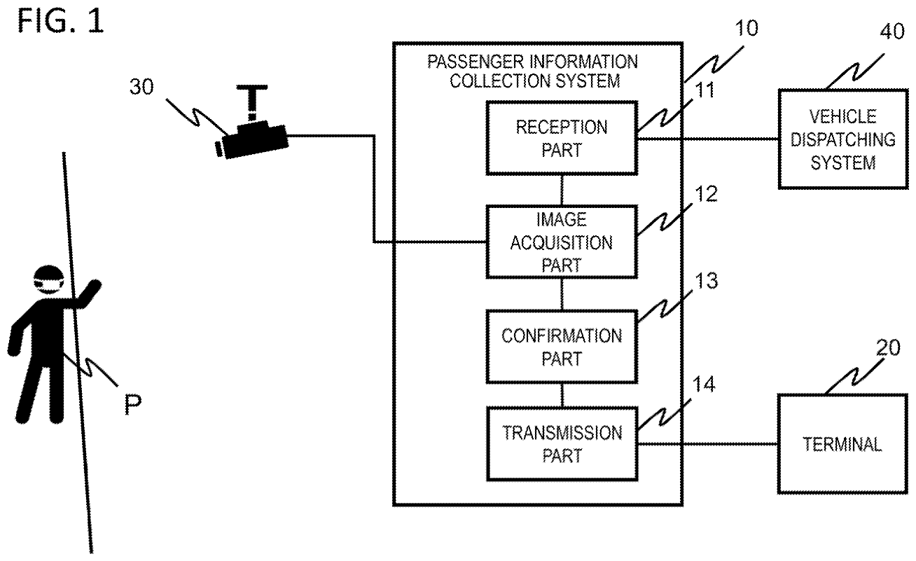

As illustrated in FIG. 1, an example embodiment of the present invention can be realized by a passenger information collection system 10 connected to a camera 30 installed in a periphery of a road. More concretely, the passenger information collection system 10 is provided with a reception part 11, an image acquisition part 12, a confirmation part 13, and a transmission part 14.

The reception part 11 receives information on a user (user information) who made a reservation from a vehicle dispatching system 40. The vehicle dispatching system 40 dispatches a passenger vehicle.

The image acquisition part 12 acquires a photographic image of a person (photographed user image) who made a dispatch request for a taxicab from the camera 30 based on the user information above.

A following scheme can be considered as a technique for the image acquisition part 12 to acquire the photographed user image of the corresponding user from the camera 30 based on the user information of the user who will use a passenger vehicle.
(1) The image acquisition part 12 collates a face, gait, etc., of the user registered in advance and a portrait image(s) photographed by the camera 30.
(2) The image acquisition part 12 receives information including location information as the user information. The image acquisition part 12 then pans, tilts, and zooms the camera 30 or selects an arbitrary camera from a plurality of cameras 30, based on the location information.

For example, location information obtained by GPS (Global Positioning System) or in-zone cell information obtained from base stations of wireless communication networks, etc., can be used for the location information.
(3) The image acquisition part 12 receives an explicit photographing request from the user who will use the passenger vehicle using a terminal, etc. carried by the user, and photographs the user with a camera 30 that can photograph the user.

The confirmation part 13 confirms whether or not a person is wearing a mask based on an image of the person in the photographed user image.

Transmission part 14 transmits information of whether or not the person who made the dispatch request for the taxicab is wearing a mask to a terminal 20 of a company to which the dispatch request for the taxicab is made. The terminal 20 may be a terminal included in the vehicle dispatching system 40.

According to the above configuration, it is possible to provide information in advance as to whether or not the person who made the dispatch request is wearing a mask. Upon acquiring this information, the company to which the dispatch request for the taxicab is made can take the following actions, if it is found that the person who made the dispatch request is not wearing a mask.
A person in charge will contact the person who made the dispatch request and ask him/her to put on a mask before boarding.
It will allocate a taxicab equipped with a mask to be rented to a passenger as a taxicab to be dispatched.
It will assign a driver who can properly handle a taxicab to be dispatched, based on the Transportation Clause, as a driver of the taxicab to be dispatched.

### FIRST EXAMPLE EMBODIMENT

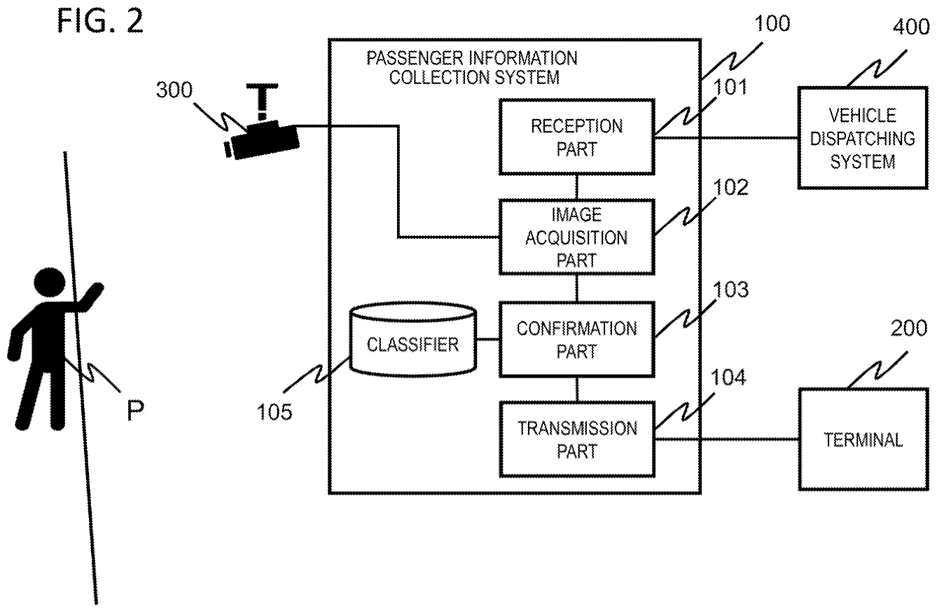

Next, a first example embodiment of the present invention will be described in detail with reference to drawings. FIG. 2 is a block drawing illustrating a configuration of a passenger information collection system 100 according to the first example embodiment of the present invention. Referring to FIG. 2, a configuration of the passenger information collection system 100 connected to a terminal 200, a camera 300, and a vehicle dispatching system 400 is illustrated.

The vehicle dispatching system 400 accepts a reservation from a user who will use a passenger vehicle specifying a date, time, pickup point, etc., and instructs an onboard terminal of the passenger vehicle to dispatch the passenger vehicle. The vehicle dispatching system 400 of the present example embodiment is also provided with a function to transmit information on the user (user information) who made the reservation above to the passenger information collection system 100.

The terminal 200 is a terminal that is an output destination of a result of collection and determination performed by the passenger information collection system 100. The terminal 200 may be a terminal that instructs a passenger vehicle(s) under control of the vehicle dispatching system 400 to dispatch a vehicle.

The camera 300 is installed at a roadside, etc., and can photograph a user who made a reservation for the passenger vehicle. The installation location of the camera 300 could be a major facility or intersection that is often designated as a pick-up location, but is not limited thereto. The camera 300 may be a camera for surveillance or security installed on sidewalks, stores, etc.

The passenger information collection system 100 is provided with a reception part 101, an image acquisition part 102, a confirmation part 103, a transmission part 104, and a classifier 105. Such a passenger information collection system 100 can be realized by a server located on a cloud infrastructure or a MEC (multi-access edge computing) server located near a service providing area.

The reception part 101 receives user information on a user who made a reservation from the vehicle dispatching system 400. The “user Information” is information that can identify the user in a photographic image photographed by the camera 300, such as an ID of the user and face image information of the user.

The image acquisition part 102 acquires a photographic image in which the user is photographed (photographed user image) from the camera 300 based on the user information above. For example, in a case where the face image information is used as the “user information”, the image acquisition part 102 cuts out a face region of a person in a photographic image photographed by the camera 300 and performs face authentication by collation with a face image of a relevant user registered in advance. When the relevant person can be detected by the face authentication, the image acquisition part 102 acquires the photographic image in which the relevant person detected as the photographed user image. It is also presumed that the camera 300 is provided with a function to cut out a face region of a person in a photographic image, perform face authentication, and put the photographic image with a tag. In this case, the image acquisition part 102 can also identify a user who will use a passenger vehicle by collating the tag and an ID of the user.

The confirmation part 103 uses the classifier 105 to confirm whether or not a person in the photographed user image is wearing a mask, and outputs a result thereof to the transmission part 104. The classifier 105 can be configured, for example, with a classification function that, upon input of image, outputs a value indicating whether or not a mask is being worn. Such a classifier 105 can be created by machine learning using pre-prepared teacher data.

The transmission part 104 transmits to the terminal 200 a result of whether or not the person in the photographed user image is wearing a mask confirmed by the confirmation part 103.

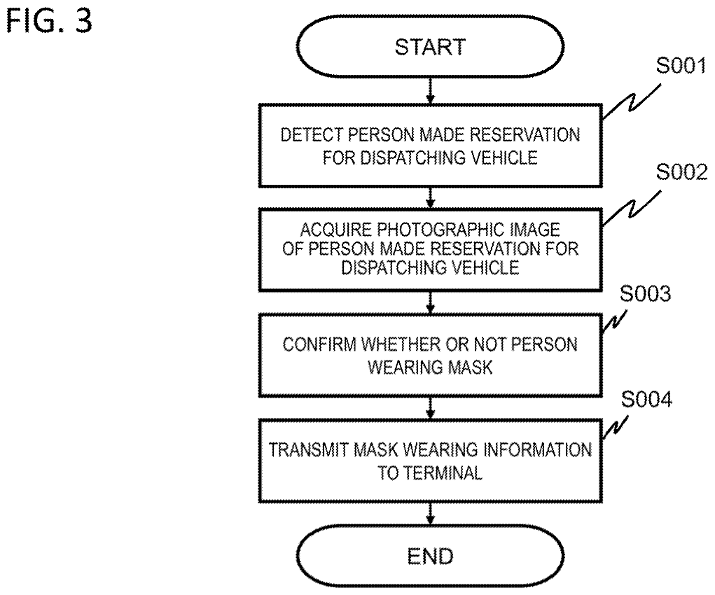

Next, an operation of the present example embodiment will be described in detail. FIG. 3 is a flowchart illustrating an operation of the passenger information collection system 100 according to the first example embodiment of the present invention.

Referring to FIG. 3, the passenger information collection system 100 first detects a person who made a reservation for dispatching the vehicle from a photographic image(s) obtained by the camera 300 (step S001).

Next, the passenger information collection system 100 acquires the photographic image in which the person detected is photographed as a photographed user image (step S002).

Next, the passenger information collection system 100 confirms whether or not the person in the photographed user image is wearing a mask (step S003).

Finally, the passenger information collection system 100 transmits to the terminal 200 information indicating whether or not the person is wearing a mask (mask wearing information) together with user information (step S004).

According to the present example embodiment that operates as described above, it is possible in advance to provide information on whether or not the person who made the dispatch request is wearing a mask to the company who manages dispatching a passenger vehicle(s), and so on.

### SECOND EXAMPLE EMBODIMENT

In the first example embodiment described above, it is explained that the passenger information collection system 100 determines whether or not a person is wearing a mask from the image of the person who made the reservation of dispatching vehicle and provides the result of determination to the company side. However, information that can be provided by the passenger information collection system 100 is not limited to this. Next, a second example embodiment of the present invention, in which a passenger information collection system 100a uses a multi-class classifier to collect information of a first attribute and information of a second attribute. The first attribute is information for selecting a driver suitable for a user (passenger), and the second attribute is information for selecting a vehicle suitable for the user.

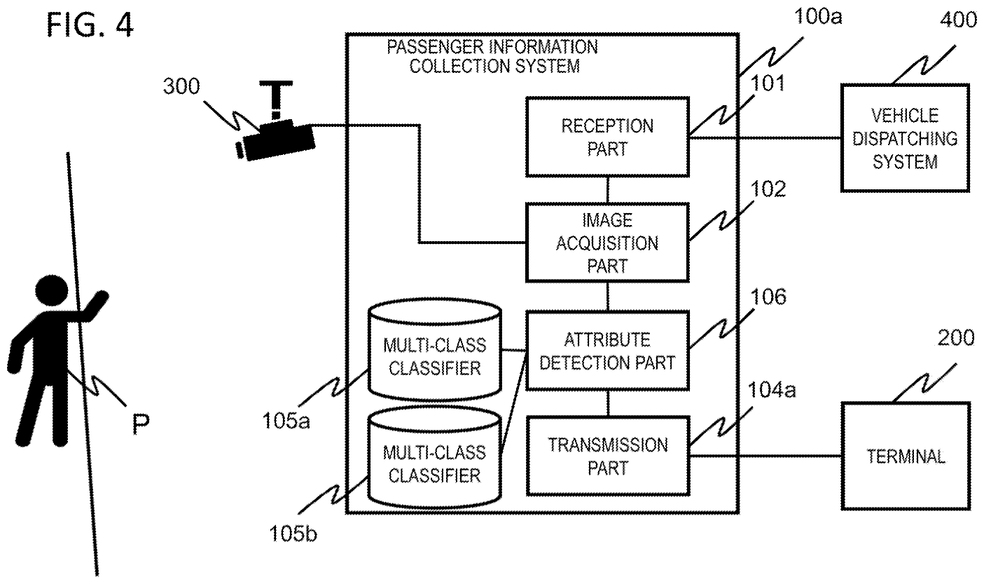

FIG. 4 is a block diagram illustrating a configuration of the passenger information collection system 100a according to the second example embodiment of the present invention. The differences from the first example embodiment illustrated in FIG. 2 reside in that the confirmation part 103 is replaced by an attribute detection part 106 and that the classifier 105 is replaced by two multi-class classifiers 105a and 105b. Since other configurations and operations are almost identical to those in the first example embodiment, the following description focuses on the differences.

The attribute detection part 106 uses the classifiers 105a and 105b to detect the first attribute and the second attribute of a person in a photographic image photographed of a user (photographed user image). Thus, the attribute detection part 106 serves as first and second attribute detection part. The first attribute is an attribute for assigning a driver suitable for the user. The first attribute may include a kind of communication language (Japanese, English, Chinese, etc.) that can be inferred (or estimated) from appearance of a person, a purpose of travel (business, sightseeing, etc.), etc. These first attributes can be detected by preparing appropriate teacher data in advance to prepare the multi-class classifier 105a that can detect (classify) the first attribute(s).

The second attribute is an attribute for allocating a vehicle suitable for the user. The second attribute may include presence or absence of a handicap that can be inferred (or estimated) from appearance of a person, etc. These second attributes can be detected by preparing appropriate teacher data in advance to prepare the multi-class classifier 105b that can detect (classify) the second attributes. Contents of the first attribute and the second attribute may overlap in part. For example, a kind of communication language (Japanese, English, Chinese, etc.), a purpose of travel (business, sightseeing, etc.), etc. may also be detected as the second attribute(s).

A transmission part 104a according to the present example embodiment transmits to the terminal 200 the first attribute(s) and the second attribute(s) detected in the attribute detection part 106.

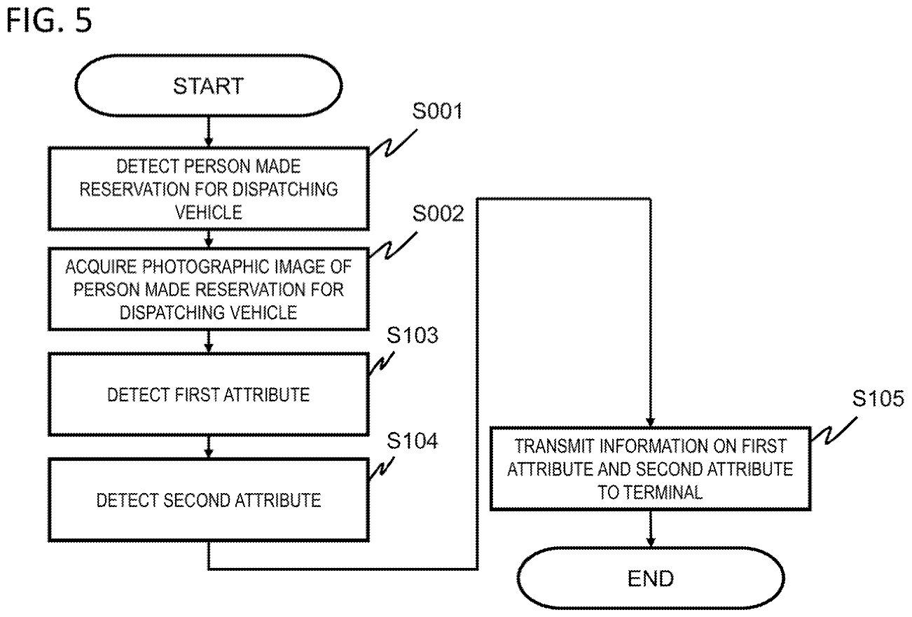

Next, an operation of the present example embodiment will be described in detail. FIG. 5 is a flowchart illustrating an operation of the passenger information collection system 100a according to the second example embodiment of the present invention. Since operations of the steps S001 to S002 in FIG. 5 are the same as those in the first example embodiment, the description thereof will be omitted.

The passenger information collection system 100a that acquired the photographic image, in which the person detected is photographed as a photographed user image, detects a first attribute of the person in the photographed user image (step S103).

Next, the passenger information collection system 100a detects a second attribute of the person in the photographed user image (step S104). Step S103 and step S104 above may be executed in parallel or in a reverse order.

Finally, the passenger information collection system 100a transmits to the terminal 200 the information on the first and second attributes together with user information (step S105).

According to the present example embodiment that operates as described above, it is possible to provide information for selecting a vehicle and a driver to be dispatched to the company that manages dispatching a passenger vehicle, and so on. Concretely a taxicab company, etc. can use the first attribute notified to select a driver who is suitable for the user. For example, if the kind of communication language inferred (or estimated) from appearance of a user is English or Chinese, the user's satisfaction can be enhanced by selecting a driver who has these conversational skills. Depending on a purpose of a travel (business, sightseeing, etc.) inferred (or estimated) from appearance of a user, a driver familiar with nearby shared offices and workplaces can be assigned, or a driver with a tourist guide qualification can be assigned.

Similarly for the second attribute, it is possible to enhance user satisfaction by, for example, selecting an appropriate vehicle according to a handicap inferred (or estimated) from appearance of the user. For example, a wheelchair user can be assigned a vehicle with a lift. If a language of communication or purpose of travel is detected as a second attribute, it is possible to assign a vehicle equipped with an interpretation terminal or with a foreign language voice guidance function.

In the present example embodiment, as in the first example embodiment, a confirmation part 103 may be provided to confirm whether or not a user is wearing a mask. This makes it possible to provide information in advance on whether or not a person who made a dispatch request is wearing a mask, in addition to information for assigning an appropriate vehicle and driver for a user.

While each example embodiment of the present invention has been described, it is to be understood that the present invention is not limited to the example embodiments above and that further modifications, replacements, or adjustments can be made without departing from the basic technical concept of the present invention. For example, the configuration of apparatus, the configuration of each element, and the expression of the data shown in each drawing are examples to facilitate understanding of the present invention and the present invention is not limited to the configurations shown in the drawings.

For example, in the second example embodiment described above, the first attribute and the second attribute are detected, but it is possible to change the configuration to detect only one of the first attribute and the second attribute.

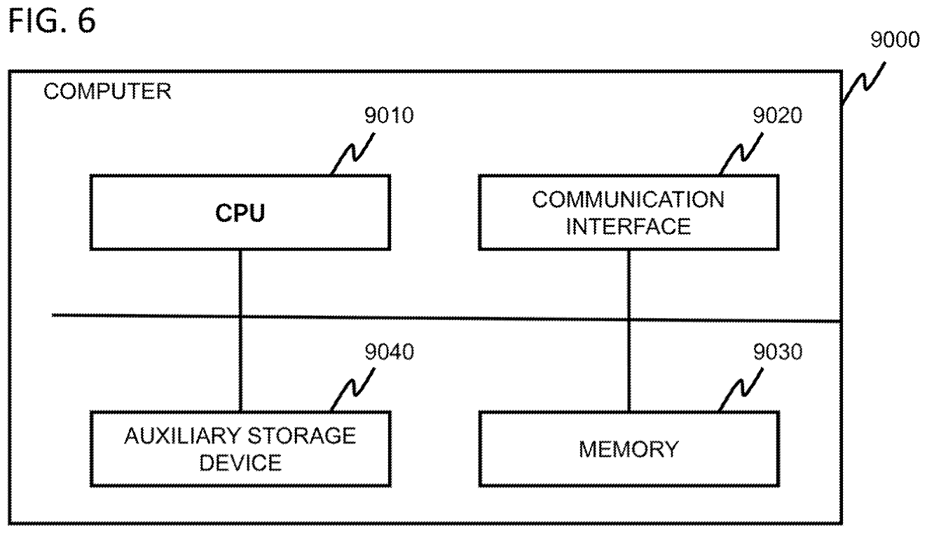

Each of the procedures described in each of the example embodiments above can be implemented by a program that causes a computer (9000 in FIG. 6) which functions as the passenger information collection system 100 or 100a to perform the function as the passenger information collection system 100 or 100a. This computer includes, for example, a CPU (Central Processing Unit) 9010, a communication interface 9020, a memory 9030, and an auxiliary storage device 9040 in FIG. 6. That is, the CPU 9010 in FIG. 6 may execute an image acquisition program and a class classification program.

In other words, each part (each processing means or function) of the passenger information collection system 100 or 100a can be implemented by a computer program causing a processor installed in the apparatus to execute each of the processes described above using the hardware thereof.

Finally, preferred modes of the present invention will be summarized. A part or the entire of the example embodiments disclosed above may be also described as the following modes, but not limited thereto.

### Mode 1

(Refer to the passenger information collection system according to the first aspect.)

### Mode 2

The passenger information collection system above may further including:
a first attribute detection part that detects a first attribute for assigning a driver suitable for the person based on the image of the person in the photographic image; wherein
the transmission part transmits information on the first attribute to the terminal of the company to which the dispatch request for the taxicab is made.

### Mode 3

The first attribute above may be a communication language that is inferred from appearance of the person, and the transmission part may transmit information on the communication language that is inferred as the first attribute to the terminal of the company to which the dispatch request for the taxicab is made.

### Mode 4

The first attribute above may be a purpose of travel that is inferred from one of clothes and a carrying object of the person, and

the transmission part may transmit information on the purpose of travel that is inferred as the first attribute to the terminal of the company to which the dispatch request for the taxicab is made.

### Mode 5

The passenger information collection system above may further including:
a second attribute detection part that detects a second attribute for allocating a vehicle suitable for the person based on the image of the person in the photographic image; wherein
the transmission part transmits information on the second attribute to the terminal of the company to which the dispatch request for the taxicab is made.

### Mode 6

The second attribute above may be a content of a handicap that is inferred from appearance of the person, and

the transmission part may transmit information on the handicap that is inferred as the second attribute to the terminal of the company to which the dispatch request for the taxicab is made.

### Mode 7

The second attribute above may be one of a communication language and a purpose of travel that is inferred from one of clothes and a carrying object of the person, and

the transmission part may transmit information on one of the communication languages and the purpose of travel that is inferred as the second attribute to the terminal of the company to which the dispatch request for the taxicab is made.

### Mode 8

(Refer to the passenger information collection method according to the second aspect.)

### Mode 9

(Refer to the program according to the third aspect.)

The above modes 8 and 9 can be expanded in the same way as mode 1 is expanded to modes 2 to 7.

The disclosure of each Patent Literature cited above is incorporated herein in its entirety by reference thereto and can be used as a basis or a part of the present invention as needed. It is to be noted that it is possible to modify or adjust the example embodiments or examples within the scope of the whole disclosure of the present invention (including the Claims) and based on the basic technical concept thereof. Further, it is possible to variously combine or select (or partially omit) a wide variety of the disclosed elements (including the individual elements of the individual claims, the individual elements of the individual example embodiments or examples, and the individual elements of the individual figures) within the scope of the disclosure of the present invention. That is, it is self-explanatory that the present invention includes any types of variations and modifications to be done by a skilled person according to the whole disclosure including the Claims and the technical concept of the present invention. Particularly, any numerical ranges disclosed herein should be interpreted that any intermediate values or subranges falling within the disclosed ranges are also concretely disclosed even without specific recital thereof. In addition, as needed and based on the gist of the present invention, partial or entire use of the individual disclosed matters in the above literatures that have been referred to in combination with what is disclosed in the present application should be deemed to be included in what is disclosed in the present application, as a part of the disclosure of the present invention.

### REFERENCE SIGNS LIST

10, 100, 100a: passenger information collection system
11: reception part
12: image acquisition part
13: confirmation part
14: transmission part
20, 200: terminal
30, 300: camera
40, 400: vehicle dispatch system
101: reception part
102: image acquisition part
103: confirmation part
104, 104a: transmission part
105: classifier
105a, 105b: multi-class classifier
106: attribute detection part
9000: computer
9010: CPU
9020: communication interface
9030: memory
9040: auxiliary storage device

What is claimed is:

1. A passenger information collection system, that is capable of acquiring a photographic image from a camera installed in a periphery of a road, comprising:
at least a processor; and
a memory in circuit communication with the processor,
wherein the processor is configured to execute program instructions stored in the memory to implement:
a reception part that receives user information on a user who made a reservation from a vehicle dispatching system that dispatches a passenger vehicle;
an image acquisition part that acquires a photographic image of a person who made a dispatch request for a taxicab, from the camera based on the user information;
a confirmation part that confirms whether or not a person is wearing a mask based on an image of the person in the photographic image; and
a transmission part that transmits information of whether or not the person who made the dispatch request for the taxicab is wearing a mask to a terminal of a company to which the dispatch request for the taxicab is made.

2. The passenger information collection system according to claim 1, wherein the processor is configured to execute the program instructions stored in the memory to implement
a first attribute detection part that detects a first attribute for assigning a driver suitable for the person based on the image of the person in the photographic image; wherein
the transmission part transmits information on the first attribute to the terminal of the company to which the dispatch request for the taxicab is made.

3. The passenger information collection system according to claim 2, wherein
the first attribute is a communication language that is inferred from appearance of the person, and
the transmission part transmits information on the communication language that is inferred as the first attribute to the terminal of the company to which the dispatch request for the taxicab is made.

4. The passenger information collection system according to claim 2, wherein
the first attribute is a purpose of travel that is inferred from one of clothes and a carrying object of the person, and
the transmission part transmits information on the purpose of travel that is inferred as the first attribute to the terminal of the company to which the dispatch request for the taxicab is made.

5. The passenger information collection system according to claim 1, wherein the processor is configured to execute the program instructions stored in the memory to implement
a second attribute detection part that detects a second attribute for allocating a vehicle suitable for the person based on the image of the person in the photographic image; wherein
the transmission part transmits information on the second attribute to the terminal of the company to which the dispatch request for the taxicab is made.

6. The passenger information collection system according to claim 5, wherein
the second attribute is a content of a handicap that is inferred from appearance of the person, and
the transmission part transmits information on the handicap that is inferred as the second attribute to the terminal of the company to which the dispatch request for the taxicab is made.

7. The passenger information collection system according to claim 5, wherein
the second attribute is one of a communication language and a purpose of travel that is inferred from one of clothes and a carrying object of the person, and
the transmission part transmits information on one of the communication languages and the purpose of travel that is inferred as the second attribute to the terminal of the company to which the dispatch request for the taxicab is made.

8. A passenger information collection method performed by a passenger information collection system capable of acquiring a photographic image from a camera installed in a periphery of a road, comprising:
receiving user information on a user who made a reservation from a vehicle dispatching system that dispatches a passenger vehicle;
acquiring a photographic image of a person who made a dispatch request for a taxicab, from the camera based on the user information;
confirming whether or not a person is wearing a mask based on an image of the person in the photographic image; and
transmitting information of whether or not the person who made the dispatch request for the taxicab is wearing a mask to a terminal of a company to which the dispatch request for the taxicab is made.

9. A non-transitory computer-readable medium storing a program causing a computer capable of acquiring a photographic image from a camera installed in a periphery of a road to execute:
a process of receiving user information on a user who made a reservation from a vehicle dispatching system that dispatches a passenger vehicle;
a process of acquiring a photographic image of a person who made a dispatch request for a taxicab, from the camera based on the user information;
a process of confirming whether or not a person is wearing a mask based on an image of the person in the photographic image; and
a process of transmitting information of whether or not the person who made the dispatch request for the taxicab is wearing a mask to a terminal of a company to which the dispatch request for the taxicab is made.

10. The passenger information collection system according to claim 2, wherein the processor is configured to execute the program instructions stored in the memory to implement
a second attribute detection part that detects a second attribute for allocating a vehicle suitable for the person based on the image of the person in the photographic image; wherein
the transmission part transmits information on the second attribute to the terminal of the company to which the dispatch request for the taxicab is made.

11. The passenger information collection system according to claim 3, wherein the processor is configured to execute the program instructions stored in the memory to implement
a second attribute detection part that detects a second attribute for allocating a vehicle suitable for the person based on the image of the person in the photographic image; wherein
the transmission part transmits information on the second attribute to the terminal of the company to which the dispatch request for the taxicab is made.

12. The passenger information collection system according to claim 4, wherein the processor is configured to execute the program instructions stored in the memory to implement
a second attribute detection part that detects a second attribute for allocating a vehicle suitable for the person based on the image of the person in the photographic image; wherein
the transmission part transmits information on the second attribute to the terminal of the company to which the dispatch request for the taxicab is made.

13. The passenger information collection method according to claim 8, further comprising:
detecting a first attribute for assigning a driver suitable for the person based on the image of the person in the photographic image; and
transmitting information on the first attribute to the terminal of the company to which the dispatch request for the taxicab is made.

14. The passenger information collection method according to claim 13, wherein
the first attribute is a communication language that is inferred from appearance of the person, and
the passenger information collection method further comprising:
transmitting information on the communication language that is inferred as the first attribute to the terminal of the company to which the dispatch request for the taxicab is made.

15. The passenger information collection method according to claim 13, wherein
the first attribute is a purpose of travel that is inferred from one of clothes and a carrying object of the person, and
the passenger information collection method further comprising:
transmitting information on the purpose of travel that is inferred as the first attribute to the terminal of the company to which the dispatch request for the taxicab is made.

16. The passenger information collection method according to claim 8, further comprising:
detecting a second attribute for allocating a vehicle suitable for the person based on the image of the person in the photographic image; and
transmitting information on the second attribute to the terminal of the company to which the dispatch request for the taxicab is made.

17. The passenger information collection method according to claim 13, further comprising:
detecting a second attribute for allocating a vehicle suitable for the person based on the image of the person in the photographic image; and
transmitting information on the second attribute to the terminal of the company to which the dispatch request for the taxicab is made.

18. The passenger information collection method according to claim 14, further comprising:
detecting a second attribute for allocating a vehicle suitable for the person based on the image of the person in the photographic image; and
transmitting information on the second attribute to the terminal of the company to which the dispatch request for the taxicab is made.

19. The passenger information collection method according to claim 15, further comprising:
detecting a second attribute for allocating a vehicle suitable for the person based on the image of the person in the photographic image; and
transmitting information on the second attribute to the terminal of the company to which the dispatch request for the taxicab is made.

20. The passenger information collection method according to claim 16, wherein
the second attribute is a content of a handicap that is inferred from appearance of the person, and
the passenger information collection method further comprising:
transmitting information on the handicap that is inferred as the second attribute to the terminal of the company to which the dispatch request for the taxicab is made.
